(19) United States
(12) Patent Application Publication
(10) Pub. No.: US 2009/0255425 A1
(43) Pub. Date: Oct. 15, 2009

(54) SCREEN PRINTING APPARATUS AND SCREEN PRINTING METHOD

(75) Inventors: Motoyuki Itoh, Saitama (JP); Kenichi Kubo, Saitama (JP)

Correspondence Address: AKERMAN SENTERFITT, P.O. BOX 3188, WEST PALM BEACH, FL, 33402-3188, US

(73) Assignee: Hitachi Metals, Ltd., Minato-ku, Tokyo (JP)

(21) Appl. No.: 11/995,594

(22) PCT Filed: Feb. 20, 2006
(86) PCT No.: PCT/JP2006/302939

§ 371 Date: Jan. 14, 2008

(30) Foreign Application Priority Data
Jul. 20, 2005 (JP) 2005-210122
Oct. 21, 2005 (JP) 2005-307496

(51) Int. Cl. B05C 17/06

(52) U.S. Cl. 101/126

(57) ABSTRACT

The invention provides a screen printing apparatus and a screen printing method with which the separability of the printing member just after printing a print material has been improved. This invention relates to a screen printing apparatus comprising: a printing means including, a printing member with elasticity and with soft magnetism, with opening corresponding to a pattern, with a print area to which a print material is supplied and in which said opening is included, with one face which is aligned with one face of said work in predetermined positional relation, and also including a supporter supporting said printing member, a feeding means supplying the print material while pushing the print area from another face of the printing member, formed so that the upper part of the printing member can move along one direction at least, and a magnetic force generating means pulling up the printing member synchronously with the feeding means, formed behind the feeding means to cover the print area along moving direction of the feeding means. The magnetic force generating means comprises two or more magnetic domains on one face facing the printing member, and magnetic poles of adjoining the magnetic domains are opposite to each other.

### FIELD OF THE INVENTION

This invention relates to a screen printing apparatus and screen printing method used for printing a print material on a work. Especially, it relates to a suitable screen printing apparatus and a screen printing method for printing soldering paste, flux, etc., in a predetermined pattern on semiconductor wafers, or electronic device, such as circuit boards on which electronic devices are mounted.

### BACKGROUND OF THE INVENTION

Hereafter, the background of this invention is explained based on the art used for printing print materials, such as soldering paste or flux, on electronic device. However, this invention is not limited only to the following description.

For example, when electronic devices, such as LSIs, capacitor elements, and resistance elements, are mounted on a circuit board, soldering pastes are printed on the circuit board at first. Then, electronic devices are mounted on the soldering pastes, then the soldering pastes are molten in the reflow process, and they are connected to the circuit board. When forming solder bumps on a wafer etc., using a solder ball, fluxes are printed on the wafer at first. Subsequently, solder balls are mounted on the fluxes, and these solder balls are molten in the reflow process, and solder bumps are formed.

Usually, in the process of printing the above-mentioned soldering paste, flux (it may be called a paste also including soldering paste and flux below.) etc., on circuit boards etc., a screen printing apparatus is used. The paste is supplied on a predetermined position in circuit board, through the opening formed in a mask which is a printing member.

The above-mentioned conventional screen printing apparatus has openings 913 corresponding to patterns of electrodes etc., located on a circuit board “W”, as shown in FIG. 10(a). After aligning a mask 911 stretched by a frame unit 912 with the circuit board “W”, paste “f” supplied on the upper surface of this mask 911, is printed, spread, and pressed to openings 913 by a squeegee 92. While paste “f” is supplied to openings 913, the mask 911 is separated from the circuit board “W”, and the paste “f” is set on the circuit board “W”. Here, the above-mentioned conventional screen printing apparatus 9 has a structure for so-called off-contact printing. Namely, the mask 911 of the screen printing apparatus 9 itself may have elasticity, instead, the mask 911 may be stretched by the frame unit 912 via the member having elasticity, and a lower face of the mask 911 may be allocated so that the distance between the lower face of the mask and upper face of the circuit board “W” is kept at a predetermined initial gap “G” (it may be called snap-off below). When the paste “f” is supplied to openings 913, the mask 911 is contacted to the circuit board “W” by the pressure by the squeegee 92, and after supply of the paste “f” is completed, it is restored to initial shape by elasticity.

Recently, since the packaging density of electronic devices increases, and the pitch between lead wires are made narrow, printing accuracy is needed, therefore, snap-off “G” becomes small. In some cases, printing mask 911 may be touched to circuit board “W”, so that what is called a contact printing is performed. Here, when being printed with narrow snap-off “G” by the off-contact printing method, as shown in FIG. 10(b), or, when being printed by the contact printing method as shown in FIG. 10(c), the paste “f” supplied to the openings 913 oozes into the gap between the mask 911 and the circuit board “W”. Therefore, the mask 911 adheres to the circuit board “W”. Therefore, it becomes difficult to separate the mask 911 from the circuit board “W”, namely, separability gets worse.

On the other hand, when snap-off “G” is made wide in order to avoid blot of paste “f”, as shown in FIG. 10(a), the stability in restoring to initial shape becomes excessive. Therefore, printed paste “f” will be deformed, and the pitch size accuracy of each printed paste “f” exceeds allowable range, therefore, printing accuracy gets worse.

In order to solve the above-mentioned problem, various analyses are made, and the examples are indicated in Japanese Patent No. 2000-85102 and Japanese Patent No. 8-34110. A screen printing apparatus for the contact printing method comprising mask, squeegee, the 1st elevator, and the 2nd elevator is indicated in Japanese Patent No. 2000-85102. Here, the mask is set so that it may contact on the surface of a circuit board, the head of the squeegee contacts with the upper surface of the mask, and the squeegee moves from one end to other end along X-axis parallel to the mask upper surface, and pushes out solder to the opening on the mask, and this squeegee is provided above the mask. The 1st elevator raises the end side of the mask upwards and peels the mask gradually from the circuit board. The 2nd elevator elevates the 1st elevator so that the angle of gradient by the side of the end of the mask to the circuit board centering on the head of the squeegee may become almost constant. The head of the squeegee and the 1st elevator are set parallel to the mask upper surface respectively, and are set along Y-axial direction perpendicular to the X-axis.

In this screen printing apparatus, the squeegee moves from one end to other end along the X-axis, and pushes out solder to the opening in the mask. Simultaneously, when the 2nd elevator raises the 1st elevator, the end side of the mask is raised upwards by the 1st elevator, and is peeled gradually from the circuit board. Under the this circumstances, deflection is not produced on the mask and the mask is peeled from the other end to the slanting upper part to the surface of the circuit board, with the head of the squeegee as the starting point. Therefore, the behavior at the time of the mask peeling becomes the same along the head of the squeegee, and the separability gets better.

However, there are the following problems that should be solved in the screen printing apparatus of Japanese Patent No. 2000-85102. The thickness of the mask used with the screen printing apparatus is very thin, such as several ten-several hundred micrometers, and the mask has flexibility. Therefore, as shown in FIG. 10(d), even if the end part of the mask 911 is always raised, portion “a” of the mask 911 immediately after filling up the opening 913 with paste “f” is not immediately separated from the circuit board “W” because of the viscosity of the paste “f” supplied to the opening 913. Therefore, the mask 911 is stuck to the circuit board W for a while.

if the mask 911 in which the opening 913 was filled up with paste “f” has stuck to the circuit board “W” even if this stuck time is a short time comparatively, the paste “f” will ooze out in the gap between the mask 911 and the circuit board “W”, therefore, the printed paste “f” is deformed, and the mask 911 is polluted with the paste “f” which oozed out.

Another screen printing apparatus, in which a mask consisting of magnetic materials is aligned with a work, and ink supplied on the mask is spread by a squeegee, the ink pattern is printed on the work, is indicated in Japanese Patent No. 8-34110. In this screen printing apparatus, an ink pattern is printed using the magnet which applies external force so that the adhesive power in the ink between the screen and the work is canceled, and the mask is separated later.

According to the screen printing apparatus of Japanese Patent No. 8-34110, the mask can be immediately separated from the work just after printing the ink by the squeegee, by the use of the magnet of the above-mentioned composition. Therefore, the separability of the mask does not get worse like the screen printing apparatus of the above-mentioned Japanese Patent No. 2000-85102.

However, recently, the number of the openings per unit area is increasing because of narrower pitch of the printing pattern, and the mask is enlarged because of enlargement of the circuit board or the wafer, the problem with the separability of the mask is remarkable. According to the magnet which is a component of the screen printing apparatus of the above-mentioned Japanese Patent No. 8-34110, the flux density of the magnet which passes along the mask becomes non-uniform for every part of the mask. Under such situation, a part of the mask may be separated from the work and the another part of the mask may not be separated because of the non-uniformity, therefore the variation in the separability may arise. This problem becomes still more remarkable when the mask is enlarged and rigidity of the mask in the center differs from that in the end. When separating the mask from the work after the paste is printed, the viscous force of this paste works between the paste filled in the opening and side face of the opening. Therefore, it is necessary to make the force on the mask more than the sum of the viscous force of each opening, so that the viscous force may be canceled. Here, if the number of the openings per unit area increases or a mask is enlarged, the sum of the above-mentioned viscous force will also increase. Therefore, it will be necessary to make the stronger force act on a mask. However, when the magnetic force of the magnet which is a component of the screen printing apparatus of the above-mentioned Japanese Patent No. 8-34110 is set stronger, the influence of the magnetic force appears also in other components of the screen printing apparatus, and an equipment configuration will become complicated to solve this problem.

### SUMMARY OF THE INVENTION

This invention is made in view of the above-mentioned conventional art. The purpose of this invention is to offer a screen printing apparatus and a screen printing method in which separability of a printing member from a work is improved, just after printing a print material, in the screen printing apparatus and screen printing method in which print material, such as soldering paste or flux etc., is printed on one face of a work in a predetermined pattern.

One embodiment of this invention is a screen printing apparatus, which prints a print material on a work in a predetermined pattern, comprising; a printing means including, a printing member with elasticity and with soft magnetism, with opening corresponding to said pattern, with a print area to which said print material is supplied and in which said opening is included, with one face which is aligned with one face of said work in predetermined positional relation, and also including a supporter supporting said printing member, a feeding means supplying said print material while pushing said print area from another face of said printing member, formed so that upper part of said printing member can move along one direction at least, a magnetic force generating means pulling up said printing member synchronously with said feeding means, formed behind said feeding means to cover said print area along moving direction of said feeding means, wherein, said magnetic force generating means comprises two or more magnetic domains on one face facing said printing member, and magnetic poles of adjoining said magnetic domains are opposite to each other. Here, a “magnetic domain” means a domain in which magnetic polarity is uniform. A “print material” is mainly in liquid state, and materials with viscosity, such as in paste state or gel state, are also included. As a soft magnetic material which constitutes a printing member, metallic materials containing magnetic stainless steel or nickel, or resin materials containing soft magnetic material particles, can be used for example.

By this screen printing apparatus, one face of the printing member is aligned with one face of the work, so that these faces are arranged in predetermined positional relation. A feeding means supplies the print material from another face of the printing member, which is aligned with the work, while the upper part of the printing member is moved form one end of the printing member to the other end, therefore, the openings in the print area are filled up with the print material.

The feeding means pushes the print area on which the print material is supplied, from another face. The printing member has both elasticity and soft magnetism. A magnetic force generating means which is located behind the feeding means and which moves synchronously with the feeding means, pulls up the printing member behind the feeding means just after pushing and supplying the print material to the openings, and the printing member is separated from the work.

Here, on one face facing the printing member used also as the magnetic force generating means, magnetic domains are arranged so that the magnetic polarity in the adjoining magnetic domain are opposite to each other. Therefore, magnetic flux is formed between the magnetic domains, and magnetic force is generated along the direction in which the printing member is pulled up. And since two or more magnetic domains are allocated, on one face of the above-mentioned magnetic force generating means, two or more magnetic forces arises corresponding to the magnetic domain.

As a result, the printing member can be uniformly pulled up by two or more of these magnetic forces. Therefore, the printing member can be made to separate uniformly from the work. According to the above-mentioned magnetic force generating means, the above-mentioned magnetic flux is mainly generated in the narrow space between magnetic domains. Therefore, even when making the magnetic force by the magnetic force generating means increase corresponding to enlargement of the printing member, or the increase in number of the openings, the influence on the other members in circumference, can be reduced. Since the printing member is pulled up by magnetic force, the magnetic force generating means and the printing member can be used in both contact condition and non-contact condition. Thus, the printing member is separated from the work by the magnetic force generating means just after supplying the print material to the openings, and the separability of the printing member just after printing becomes excellent, therefore, the print material supplied to the openings is hard to ooze out in the gap between the work and the printing member. Since the magnetic force generating means is formed so that the print area may be covered with, wholly the print area is pulled up uniformly, therefore, there is little variation in the printing condition for every part of the work, and the quality of printing is stabilized. Separability of the printing member can be made more uniform by the magnetic force generating means of the above-mentioned composition, and also the quality of printing is improved. Since a configuration will become simpler when permanent magnets are assembled in the above-mentioned composition and are used as the magnetic force generating means, it is desirable.

In the screen printing apparatus of the above-mentioned embodiment, adjoining magnetic domains may be in contact with each other preferably. By this composition, magnetic force can be generated for every magnetic domain by the leaked magnetic field generated between magnetic domains. In that case, in order to suppress the influence of the generated magnetic force on another face of the magnetic force generating means, it is more preferred that a piece with soft magnetism which can cover the another face is allocated on this side. By this composition, since the magnetic flux generated between magnetic poles on another face passes through the piece with soft magnetism, the influence of the magnetism on the circumference can be reduced.

And, said adjoining magnetic domains may be formed not to be in contact with each other, and magnetic domains on a face facing said one face of said magnetic force generating means may be combined magnetically. Also by this composition, magnetic force may be generated between each magnetic domain by magnetic flux generated for every magnetic domain, and since said another faces are combined magnetically, the influence on the circumference of the generated magnetic force generated on the another face, can be reduced.

And, said magnetic domains may be located in line being at certain angles with moving direction of said feeding means. Thus, by making magnetic domains into such composition, printing member facing these magnetic domains in line may be uniformly separated from the work. The direction along the lined magnetic domains may be perpendicular to the moving direction of said feeding means, or may be along the moving direction.

In the above mentioned screen printing apparatus, vibrating means vibrating the printing member may be formed preferably, and the printing member may be vibrated when the printing member is pulled up, thereby, since the viscous force between the wall of openings and the print material may be reduced, and the printing member may be easily separated, and the shape of the printed print material may becomes excellent. Or, pulling up control means, which can control the pulling up operation in two or more patterns, may be formed, by this means, pulling up operation may be set suitably, and the similar effect can be given also. A heating method heating the printing member may be formed, by this means, the printing member may be heated when it is pulled up, similar effect can be given also.

Although the work and the printing material used for this screen printing apparatus are not limited, it is preferred to print a print material containing flux component such as soldering paste or flux, on a work which is wafer, electric device such as circuit board, thereby printing may be done for electric device with narrow pitch wiring circuit etc., recently.

And, moving means moving the feeding means may be formed preferably, by this means, because the feeding means may be moved automatically, it is desirable for stability of production, and also movement control means which controls moving speed by the moving means may be formed, thereby, the moving speed of the feeding means can be adjusted suitably corresponding to size of the openings (that is, the size of printed print material) or viscosity of the print material, etc., and the openings can be filled with the print material properly.

The above-mentioned feeding means may comprise a jet part which injects the print material from a head and supplies it to the print area by spray method, and the pushing part which pushes the print area, or it may comprise a rotating coater which supply and spread the print material on the print area and is rotatable, and the pushing part preferably. However, a squeegee in which one end is located so that the another face of the printing member is pushed by the end, is preferred as the feeding means. Because an apparatus configuration becomes simple, and print material may be easily supplied to the openings certainly. A pressure control means to control the pressure of the squeegee on the printing member may be formed preferably, since the pressure of the squeegee is suitably controlled by granularity of the printed print material, viscosity of the print material etc., and openings can be more certainly filled up with the print material.

Off-contact method, in which the one face of said printing member is aligned with the another face of the work so that distance between these are to be predetermined value, is preferred. By printing by off-contact method, the printing member pulled up by the magnetic force generating means is restored to the initial state in which the printing member have predetermined distance to the work. Thus, by using the off-contact method, the gap between the separated printing member and the work may be kept at constant. Therefore, the magnetic force generating means may be formed preferably to cover a part of the print area along the moving direction of the feeding means, therefore, an apparatus configuration becomes simple.

In addition, pulling force control means controlling the pulling force which acts on the printing member by the magnetic force generating means, so that the pull distance of the printing member by the magnetic force generating means can be adjusted, may be formed preferably. The rigidity is not uniform in the printing member supported by the supporter, therefore, when the printing member is pulled up by the same pulling force, pull distance and pulling speed are larger in the central section of the printing member apart from the supporter, with low rigidity, and these are smaller in the edge section near the supporter, with high rigidity. By the above-mentioned pulling force control means, since the pulling force can be adjusted so that the amount of pulling force and pulling speed of the printing member may be almost uniform, the separability of the printing member can be made uniform wherever the part of the printing member is. As the pulling force control means, for example, an elevator means which can elevate the magnetic force generating means to the another face of the printing member, can be used. Otherwise, using electromagnets for the magnetic force generating means, a control means which controls the magnetic force generated from the electromagnets may be formed preferably, and by adjusting the magnetic force by the electromagnets depending on the position of the printing member, the similar effect as mentioned above may be given. Otherwise, a measurement means which measure the pull distance or the pulling speed may be formed preferably, and by adjusting the pulling force depending on the measured pull distance or the pulling speed measured by the measurement means, the separability can be made more uniform.

The magnetic force generating means may comprise preferably two or more magnetic force generating parts, in which each pulling force is controlled separately. Also along the direction perpendicular to the moving direction of the feeding means, pull distance is larger in the central section of the printing member apart from the supporter, with low rigidity, and that is smaller in the edge section near the supporter, with high rigidity. Since by the magnetic force generating means comprising two or more above-mentioned magnetic force generating parts, the pulling force by the magnetic force generating means can be adjusted depending on the position of the printing member so that the pull distance or pulling speed of the printing member may become uniform, separability of the printing member can be made uniform.

Another embodiment of this invention is a screen printing method realized with the screen printing apparatus of the above-mentioned embodiment, and this is a screen printing method to print a print material on a work in a predetermined pattern, comprising the steps of; aligning one face of an elastic printing member including opening corresponding to said pattern, with one face of said work, in predetermined positional relation, pushing print area to which said print material is supplied onto said printing member by another face of said printing member, and supplying said print material on said print area while moving a feeding means from one end to another end of said printing member, pulling up said printing member synchronously with said feeding means just after said print material is supplied on said print area, so that pull distance is set almost uniform along the direction perpendicular to said moving direction of said feeding means.

In this screen printing method, as aforementioned, said printing member is preferred to be pulled up by the magnetic force by two or more magnetic domains. And when the feeding means moves from one end to another end, pull distance of the printing member may be kept almost constant preferably, because the separability can be made uniform. According to the screen printing apparatus and screen printing method which are the embodiments of above-mentioned this invention, print area, in which the printing member is aligned with the work, and the print material pressurized is supplied by the feeding means, is formed. The magnetic force generating means of the above-mentioned composition is allocated so that this print area may be included behind this feeding means to the moving direction of the feeding means, this magnetic force generating means moves synchronously with the feeding means, and pulls up the printing member up, since this magnetic force generating means was formed, the printing member is pulled up by the magnetic force generating means just after filling up the opening in the printing member with the print material. Therefore, the separability of the printing member just after printing the print material is improved. As a result, the print material becomes hard to ooze out between the printing member and the work. Therefore, a screen printing apparatus and a screen printing method, by which accuracy of shape and dimension of the print material printed on the work is excellent, with little print material contamination of the printing member, can be offered.

### BRIEF DESCRIPTION OF THE DRAWINGS

FIG. 1 is a perspective view showing the outline composition of the screen printing apparatus of the 1st embodiment of this invention.

FIG. 2 is a perspective view of the wafer used with the screen printing apparatus shown in FIG. 1.

FIG. 3 is an expanded sectional view of the screen printing apparatus in FIG. 1, and a top view of it.

FIG. 4 is a sectional view showing the embodiment of the magnetic force generating means of the screen printing apparatus in FIG. 1.

FIG. 5 is a figure explaining operation of the screen printing apparatus in FIG. 1.

FIG. 6 is a sectional view showing the modification of the screen printing apparatus in FIG. 1.

FIG. 7 is a sectional view showing the outline composition of the screen printing apparatus of the 2nd embodiment of this invention.

FIG. 8 is a sectional view showing the outline composition of the screen printing apparatus of the 3rd embodiment of this invention.

FIG. 9 is a figure explaining the state where the mask in FIG. 1 is deformed by magnetic force generating means.

FIG. 10 is a figure explaining operation of the conventional screen printing apparatus.

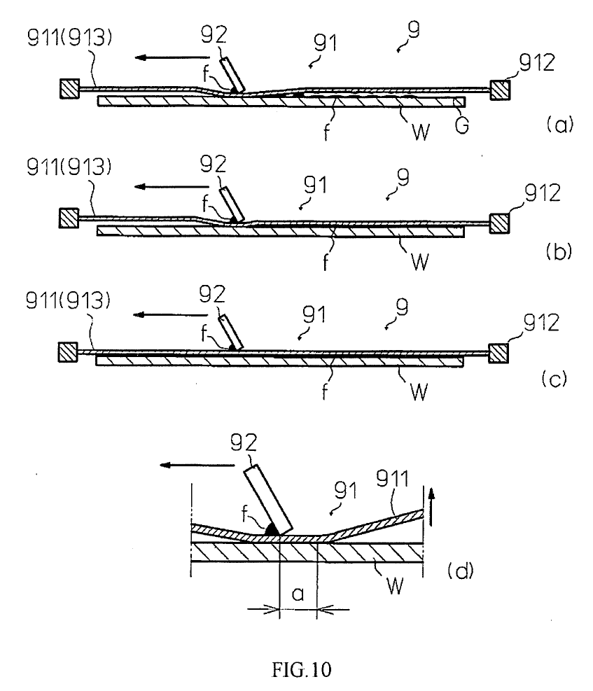

FIG. 11 is a perspective view showing the outline composition of the screen printing apparatus of the 4th embodiment of this invention.

FIG. 12 is a perspective view showing the outline composition of the screen printing apparatus of the 4th embodiment of this invention.

FIG. 13 is a figure explaining the detail of the magnetic force generating means of the screen printing apparatus in FIG. 1.

### DETAILED DESCRIPTION OF THE INVENTION

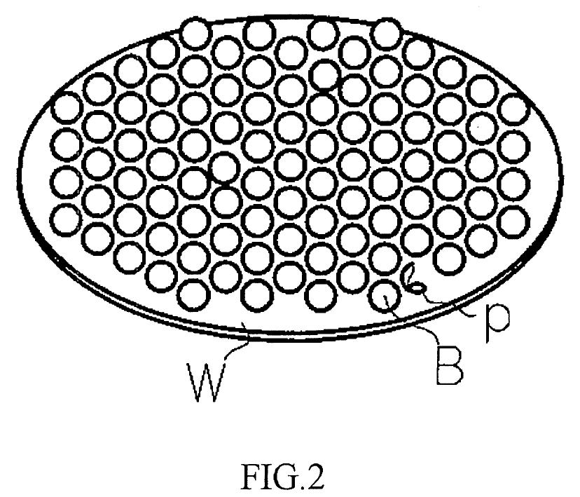

It is explained referring to figures for this invention based on the various embodiments. The work used with the screen printing apparatus of an embodiment explained below is wafer “W” by which solder ball “B” about 80-150 micrometers in diameter is mounted on plate shaped electrode “p” arranged in the predetermined pattern, as shown in FIG. 2, here, the paste state flux which is a print material, is printed on plate shaped electrode “p”.

### The 1^{st} Embodiment

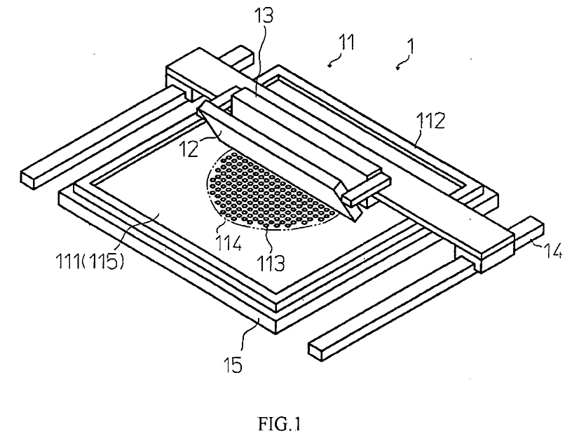

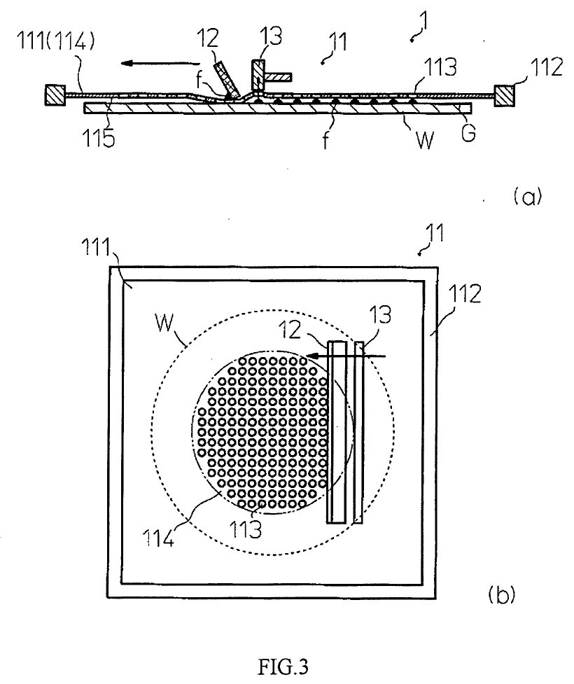

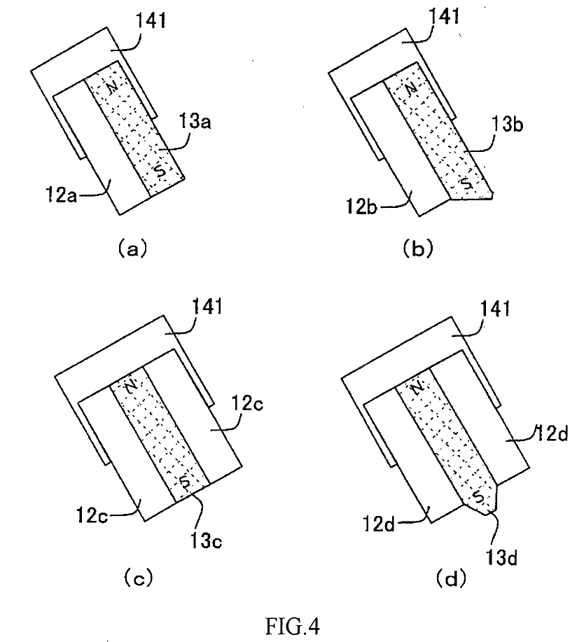

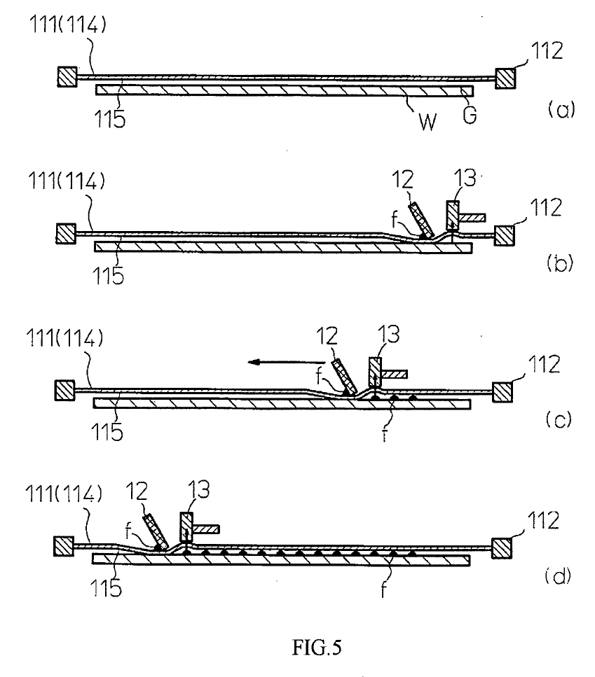

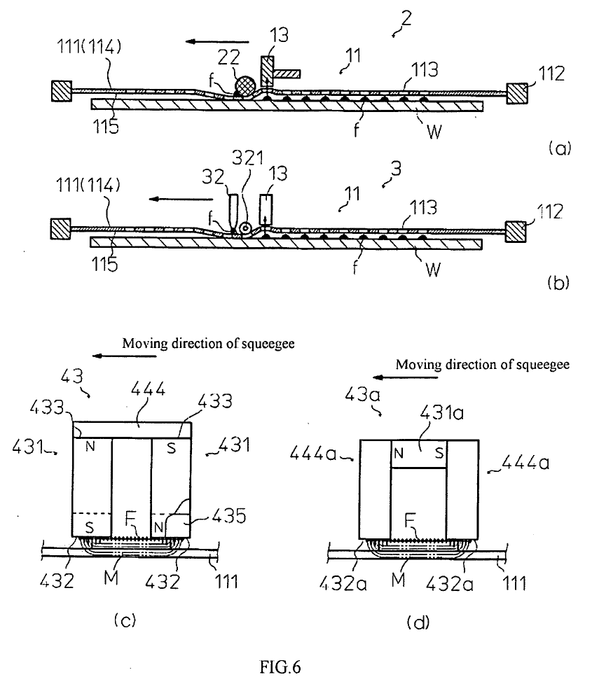

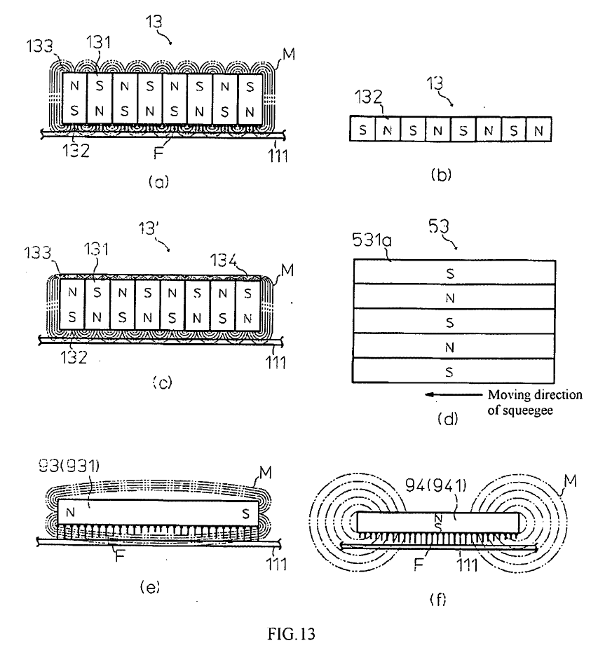

The 1st embodiment of this invention is explained based on FIGS. 1, 3-6, and 13. FIG. 1 is a perspective view showing the outline composition of a screen printing apparatus 1 of the 1^{st} embodiment. FIG. 3 is an expanded sectional view and top view of the screen printing apparatus of FIG. 1. FIG. 4 is a sectional view showing the embodiment of the magnetic force generating means of FIG. 1. FIG. 5 is a figure explaining operation of the screen printing apparatus of FIG. 1. FIG. 6 is a sectional view showing the modification of the feeding means of the screen printing apparatus of FIG. 1, and a magnetic force generating means. FIG. 13 is a sectional view of the magnetic force generating means of the screen printing apparatus of FIG. 1.

### Printing Means

In screen printing apparatus 1 of the 1st embodiment, numerals 11 show a printing means. The printing means 11 comprises a frame shape supporter 112 which supports a plate-like mask (printing member) 111 which has elasticity or is stretched from the circumference by a member which has elasticity, and this mask 111. Two or more openings 113 corresponding to the arrangement pattern of the plate shaped electrode “p” on the above-mentioned wafer “W” are formed in mask 111. The mask 111 comprises a print area 114 containing two or more openings 113 with which flux “f” is filled up, and a rear face (one face) 115 aligned with the upper face (one face) of wafer “W”, in which the plate shaped electrodes “p” are arranged. The mask 111 comprises magnetic stainless steel with soft magnetism, and the thickness is about 50 micrometers. The thickness of the mask 111 is suitably set up in consideration of the size of the solder balls, the size of the plate shaped electrodes “p”, etc. The openings 113 can be formed, for example with well-known processing methods, such as laser drilling, etching process, and precise electrofoaming.

Here, since the screen printing apparatus 1 adopts the off-contact printing method, as shown in FIG. 3(a), the mask 111 of the 1st embodiment is aligned, so that the gap between the upper face of the wafer “W” and the rear face 115 is set to a predetermined value, namely, a snap-off G. In addition, the numeral 15 in FIG. 1 shows the table with a plate shape, on which the wafer “W” is mounted. If the vacuum chucking means etc., which carry out vacuum chucking of the wafer “W” are included in this table 15, since the laid wafer “W” is chucked on the table 15 and fixed.

### Feeding Means

Numerals 12 show the plate-shaped squeegee composed of plastics or rubbers, which is a feeding means of the 1st embodiment. The squeegee 12 is allocated so that the lower end may push the print area 114 downward in contact with the upper surface of the mask 111 aligned with the wafer “W”. The size of squeegee 12 can cover the print area 114. The squeegee 12 is attached to a horizontally movable horizontal displacement means 14 which can move from one end of the mask 111 toward the other end, as shown in FIG. 1, and the squeegee 12 supplies flux “f” supplied to the upper surface of the mask 111 to the print area 114, presses it, and fills up the opening 113 with the flux “f”.

### Magnetic Force Generating Means

Numerals 13 show the magnetic force generating means which pulls the mask 111 up, as shown in FIG. 3(a). The magnetic force generating means 13 is fixed to the horizontal displacement means 14 so that it may be located behind the squeegee 12 to the moving direction of the squeegee 12 driven by the horizontal displacement means 14 and the magnetic force generating means 13 moves synchronously with the squeegee 12, keeping the distance to the squeegee 12 constant. The magnetic force generating means 13 has the same size as the squeegee 12 along the direction perpendicular to the moving direction of the squeegee 12, as shown in FIG. 3(b), this size can cover the print area 114 in the mask 111. Also it is provided so that a part of the print area 114 may be covered along the direction parallel to the moving direction.

A squeegee and the magnetic force generating means do not need to be separated as mentioned above. For example, as magnetic force generating means 13a shown in FIG. 4 (a), it may be set behind the squeegee 12a so that the mask 111 can be pulled up just after filling up the opening 113 with flux “f”, and so that it may be close to the squeegee 12a connected to the support member 141 of the horizontal displacement means. As shown in FIG. 4(b), strength and direction of the magnetic field which acts on the mask 111 from the magnetic force generating means 13b, can be adjusted by setting up suitably the position and dimension along the perpendicular direction of the permanent magnet 13b. As shown in FIG. 4(c), a pair of squeegees 12c can be set into the support member 141 of the horizontal displacement means via the permanent magnet 13c, while attaching to this permanent magnet 13c. Here, corresponding to the reciprocation of the squeegee 12c, and said support member 141 can be made tiltable so that the lower end of one of the squeegees 12c may contact the mask 111. According to this composition, it can respond to the screen printing apparatus in which the openings 113 are filled with flux “f” by reciprocation of a squeegee. As shown in FIG. 4(d), strength and direction of the magnetic field which acts on the mask 111 from the permanent magnet 13d, can be adjusted by setting up suitably the position and dimension along the perpendicular direction of the permanent magnet 13d.

Hereafter, the magnetic force generating means 13 is explained in full detail with reference to FIG. 13. The magnetic force generating means 13 of this embodiment specifically forms two or more magnetic domains 132, as shown in the FIG. 13 (a), which is the front view, also as shown in the FIG. 13 (b), which is the bottom view. Here, two or more prismatic bar magnets 131 with N and S pole at both ends are arranged in one row attaching mutually, and it is allocated so that the direction along which the magnetic domains 132 are located is perpendicular to the moving direction of the squeegee 12. In the magnetic force generating means 13, on the underside facing the mask 111, the magnetic force generating means 13 is constituted so that the adjoining magnetic domains 132 have opposite magnetic pole mutually (for example, N pole, S pole, N pole, S pole—in order). In the figure, as shown by numerals “M”, magnetic flux is formed between each magnetic domain 132. In the magnetic domain 132, the magnetic force along the perpendicular direction, namely the direction along which the mask 111 is pulled up, as shown by arrow “F”. This magnetic flux “M” is the leaked magnetic flux which leaked between the magnetic domains 132, and is specifically formed between each magnetic domain 132. Therefore, in two or more magnetic domains 132 of the above-mentioned composition, magnetic force “F” is generated separately, respectively. Thus, the magnetic force “F” which pulls up the mask 111 does not concentrate on a part, but is distributing over the whole magnetic force generating means 13. Therefore, the mask 111 can be pulled up uniformly and can be uniformly separated from the substrate “W”.

On the other hand, when the magnetic force generating means 93 comprises a magnet 931 which is shown in FIG. 13(e) and with which the S poles and N poles are located horizontally, magnetic force “F” generated by this magnetic force generating means 93 becomes weaker at the center, than at the edge of the magnet 931, as illustrated. As a result, situation in which the mask 111 is pulled up in the portion which faces the end of the magnet 931, and that which faces the center of the magnet 931, are different. Thus, in the magnetic force generating means 93 of the above-mentioned composition, the mask 111 cannot be pulled up uniformly and the mask 111 cannot be uniformly separated from the substrate “W”. When the magnetic force “F” is stronger corresponding to enlargement of the mask 111, or the increase in the number of openings 113, since the magnetic force “F” which does not act on the mask 111 directly also becomes stronger, the influence of this magnetic force “F” on the circumference also becomes larger.

When the magnetic force generating means 94 comprises a magnet 941 with which the S poles and N poles are located in the perpendicular direction shown in FIG. 13(f), magnetic force “F” generated by this magnetic force generating means 94 becomes stronger at the center, than at the edge of the magnet 941. Therefore, the mask 111 cannot be uniformly pulled up like the above-mentioned magnetic force generating means 93, and the influence of this magnetic force “F” on the circumference becomes larger, when the magnetic force “F” is made stronger. In addition, since the magnet 941 with this structure is hard to be made thin, there is also a problem of becoming thick in the perpendicular direction.

In the magnetic force generating means 13 of this above-mentioned embodiment, when the thickness of the mask 111 is thin, the magnetic force “F” in each magnetic domain 132 is usually set up to be almost same. However, it is not necessary to be the same size, and what is necessary is just to set up suitably so that the situation in which the mask 111 is pulled up may become uniform over the mask 111. For example, the magnetic force “F” in the magnetic domain 132 which faces the portion with high rigidity which is hard to be deformed, for example, the end of the mask 111 near the supporter 112, may be strengthened. On the other hand, if the magnetic force “F” in the portion which faces the central section of the mask 111 where rigidity is low and can be deformed easily, is made weaker, the mask 111 can be pulled up uniformly.

Each magnetic domain can be made by magnetizing the unified magnetic material suitably. As shown in FIG. 13 (c), in order to suppress the magnetic force generated by the magnetic domain 133 in the upper surface of the magnetic force generating means 13′, it is preferred to set piece with the soft magnetism 134 which can cover this upper surface in size, on the upper surface side.

And, since magnetic force “F” is not uniform also in each magnetic domain 132 by the magnetic force generating means 13 of the above-mentioned composition, as shown in FIG. 13 (a), the magnetic domain 132 is preferred to be as small as possible. By making the magnetic domain 132 small, the strength of the magnetic force “F” can be set more uniform, and it becomes possible to separate the mask 111 from the substrate “W” uniformly.

### Operation of the Screen Printing Apparatus of the Embodiment 1

Operation of the screen printing apparatus of the above-mentioned composition is explained with reference to FIG. 5. First, as shown in FIG. 5(a), the wafer W is laid in the predetermined position on the table 15 (not-illustrated), and the mask 111 is aligned, so that the distance between the upper surface of the wafer “W” and the rear face 115 of the mask 111 is set to a predetermined snap-off “G”.

Subsequently, flux “f” is supplied to the upper surface of the mask 111, and the flux “f” is pressurized, while attaching the lower end of squeegee 12 to the right end (one end) of the mask 111, and pushing the mask 111 to the wafer “W”, as shown in FIG. 5(b). Since the mask 111 has elasticity, the portion to which the squeegee 12 is attached is bended, and the portion is attached to the upper surface of the wafer “W”. A magnetic force generating means 13 formed behind the squeegee 12 pulls up the mask 111 which exists under this magnetic force generating means 13.

Subsequently, as shown in FIG. 5(c), the squeegee 12 is moved by a horizontal displacement means 14 toward a left end (other end) from the right end of the mask 111. With this movement, the squeegee 12 applies flux “f” to a print area 114, extends it, and fills up openings 113 with it and presses it. Here, the permanent magnet 13 moved in the back of this squeegee 12, synchronously with the squeegee 12. Therefore, just after filling up the openings 113 with flux “f”, the mask 111 can be pulled up by the magnetic force generating means 13, and is restored to the initial state with the snap-off “G”. Since the magnetic force generating means 13 is formed to cover the print area 114 behind the squeegee 12 in size, along the moving direction of the squeegee 12 and it comprises two or more magnetic domains still as mentioned above, the mask 111 which is located underneath the magnetic force generating means 13, can be pulled up upwards uniformly.

Subsequently, as shown in FIG. 5(d), the squeegee 12 is moved to the left end of the mask 111, and printing of flux “f” is completed.

### Modification to the Screen Printing Apparatus of the Embodiment 1

In FIG. 6 showing the modification of the screen printing apparatus of the embodiment 1, the screen printing apparatus comprising modification of the feeding means of the screen printing apparatus of the 1st embodiment, a magnetic force generating means, is shown. In FIGS. 6(c) and (d), while attaching the same numerals for same components as the screen printing apparatus shown in FIG. 1, only a magnetic force generating means is shown and other components, such as a printing means, are omitted.

In order that the feeding means 22 of the screen printing apparatus in FIG. 6(a) may supply and extend flux “f” to the upper surface of the mask 111 and may supply it to the print area 114, it comprises a rotating coater 22 which pushes the mask 111 to the wafer “W” contacting with the mask 111, and is rotatable.

The feeding means 32 in the screen printing apparatus in FIG. 6 (b) supplies flux “f” to the print area 114 from the upper surface side of the mask 111. Thereby, it comprises a jet unit 32 which injects flux “f” from its head and supply the flux to the print area 114, and a pressurization unit 321 which fills opening 113 with the flux, and pressurizes the flux in the print area 114, and pushes the mask 111 to the wafer “W”.

In FIG. 6(c), the numeral 43 shows magnetic force generating means, and it comprises two permanent magnets 431 and piece with soft magnetism 444. Along the direction perpendicular to the moving direction of a squeegee (not-illustrated), approximately plate-shaped permanent magnet 431 can cover the print area (not-illustrated) on a mask in size. Permanent magnets 431 are allocated so that magnetic poles of domains 432, namely the magnetic pole of underside facing the mask may be opposite to each other, so that one pole is set to N pole and the other pole is set to P pole. Here, the magnetic domains 432 are allocated side by side in parallel to the moving direction of the squeegee, being separated from the squeegee. Piece with soft magnetism 444 is allocated, contacting with the upper surface of permanent magnet 431, so that magnetic domains 433 on the upper face opposite to said magnetic domain 432, may be combined magnetically mutually. By magnetic force generating means 43 of this composition, between two magnetic domains 432 to which the mask is approached, the magnetic flux shown with numerals “M” in the figure is generated, therefore, magnetic force “F” is generated in each magnetic domain 432, and the mask can be separated uniformly, as by the above-mentioned magnetic force generating means 13. When the strength of the magnetic force needs to be partially adjusted corresponding to the rigidity of the mask, etc., as shown in numerals 435, dents can be made on the underside of the permanent magnet 431 partially, thereby, magnetic force can be partially adjusted by adjusting the gap between the upper surface of the mask and the underside of permanent magnet 431. Magnetic domains 432 may be allocated side by side so that these domains intersect the moving direction of the squeegee. When it is necessary to pull up the mask in wide area, the magnetic force generating means may comprise two or more permanent magnets.

In FIG. 6(d), numerals 43a shows magnetic force generating means, and it has the same composition as the above-mentioned magnetic force generating means 43 in magnetic circuit. Namely, the magnetic force generating means 43a comprise one permanent magnet 431a and two pieces with soft magnetism 444a. Along the direction perpendicular to the moving direction of a squeegee (not-illustrated), approximately plate-shaped permanent magnet 431a and piece with soft magnetism 444a can cover the print area (not-illustrated) of a mask in size. S pole and a N pole are horizontally formed in permanent magnet 431a, and the upper part of piece with soft magnetism 444a is contacted with each pole of permanent magnet 431a, therefore, S pole or N pole is formed in the underside of piece with soft magnetism 444a, or in separated magnetic domains 432a. By the magnetic force generating means 43a of this composition, the mask can be separated uniformly as magnetic force generating means 43. Without using single permanent magnet as mentioned above, two or more permanent magnets may be suitably arranged instead, so that the print area on the mask is covered.

### The 2^{nd} Embodiment

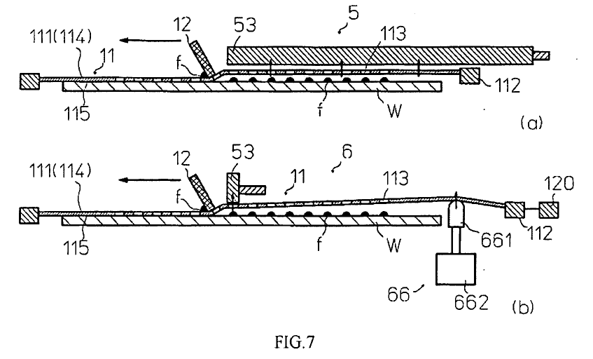

Although the screen printing apparatus 1 of the 1st embodiment was used for off-contact printing method, this invention can be carried out also with the screen printing apparatus for contact printing method. The 2nd embodiment of this invention which is the screen printing apparatus for contact printing method, is explained with reference to FIG. 7. FIG. 7 is a sectional view showing the outline composition of screen printing apparatus 5 and 6 of the 2^{nd} embodiment, and the table 15 and the horizontal displacement means 14 are omitted. While attaching same numerals for same components as screen printing apparatus 1 of the 1st embodiment, explanations are omitted for these components.

The mask 111 in the screen printing apparatus 5 of FIG. 7(a) is allocated so that the rear face 115 may be aligned and attached to the upper surface of the wafer “W”. Numeral 53 shows the magnetic force generating means of this embodiment. The magnetic force generating means 53 is fixed to a horizontal displacement means 14 so that it may be located behind this squeegee 12 along the moving direction of the squeegee 12 driven by the horizontal displacement means 14. The magnetic force generating means 53 moves synchronously with the squeegee 12, keeping the distance to the squeegee 12 at a predetermined value. The magnetic force generating means 53 can cover the whole print area 114 behind the squeegee 12 along the moving direction of the squeegee 12 in size. Fundamentally, this magnetic force generating means 53 is constituted similarly to said magnetic force generating means 13 of the 1st embodiment. As shown in FIG. 13(d) which is the bottom view, the S poles and N poles are arranged so that magnetic poles of adjoining magnetic domains 531a are opposite to each other, and each pole comprises cylindrical magnet extending along the moving direction of the squeegee 12. In this screen printing apparatus 5, the mask 111 may be pulled up while the magnetic force generating means 53 and the mask 111 are not contacting with each other.

In this screen printing apparatus 5, after flux “f” supplied to the upper surface of the mask 111 fills the opening 113 by the squeegee 12, the mask 111 is pulled upward by the magnetic force generating means 53. Since the magnetic force generating means 53 is formed to cover the whole print area 114 behind the squeegee 12 along the moving direction of the squeegee 12, pulled mask 111 is kept on being separated from the wafer “W” by the magnetic force generating means 53. Therefore, in screen printing apparatus 5 for contact printing method, while the separability of the mask 111 just after printing is improved, the mask 111 which had been separated once does not contact with the upper surface of the wafer “W” again.

The mask 111 of the screen printing apparatus 6 in FIG. 7(b) is set to contact with the upper surface of the wafer W by its back face 115, and to be aligned. The screen printing apparatus 6 has the same magnetic force generating means 13 as the 1st embodiment of the above, and the pushing up means 66 which is located in the right end part of the mask 111, and pushes up the mask 111 upwards from the lower part of the mask 111.

The pushing up means 66 comprises a pushing up member 661 which pushes up the right end part of the mask 111 upwards, and make it separate from the wafer W, and an elevator 662 which elevates the pushing up member 661. The pushing up member 661 is formed into plate-shaped along the direction vertical to the figure. Numerals 120 show the tension control means which controls the tension of the mask 111, and printing accuracy is maintained by keeping the tension of the mask 111 pushed up by the pushing up means 66 uniform.

By this screen printing apparatus 6, after flux “f” supplied to the upper surface of the mask 111 fills openings 113 by the squeegee 12, the mask 111 is pulled upwards by the magnetic force generating means 13. Here, the pushing up means 66 pushes the mask 111 up, when the squeegee 12 starts to move from the right end, and keeps the mask 111 pulled up by the magnetic force generating means 13 on being separated from the wafer “W”. Therefore, in the screen printing apparatus 6 for contact printing method, while the separability of the mask 111 just after printing is improved, the mask 111 which had been separated once does not contact with the upper surface of the wafer “W” again. In the case of this embodiment, in the frame shaped supporter 112, a member parallel to the moving direction of the squeegee 12 is preferred to be deformable within a vertical plane.

### The 3^{rd} Embodiment

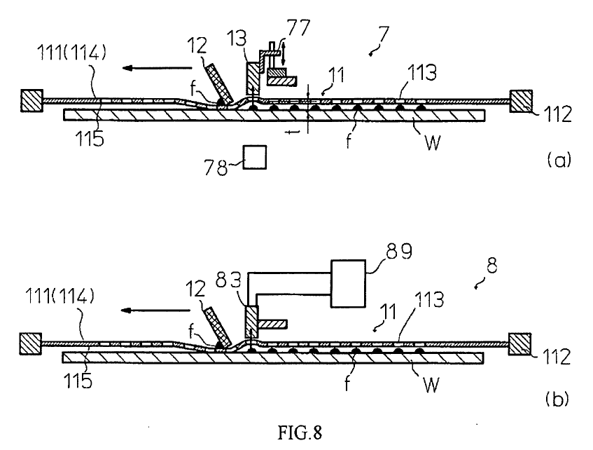

The 3rd embodiment of this invention is explained with reference to FIG. 8. FIG. 8 shows a sectional view showing the outline composition of the screen printing apparatus 7 and 8 of the 3rd embodiment. Here, the table 15 and the horizontal displacement means 14 are omitted. While attaching same numerals for same components as screen printing apparatus 1 of the 1st embodiment, explanations are omitted for these components.

As shown by the arrow, in the screen printing apparatus 7 in FIG. 8(a) by the arrow, an elevator means (pulling force control means) 77 which elevates the magnetic force generating means 13 is formed, and a measurement means 78 which measures the distance “t” between the back face 115 of the mask 111 in the lower part of the magnetic force generating means 13 and the wafer “W”, is also formed.

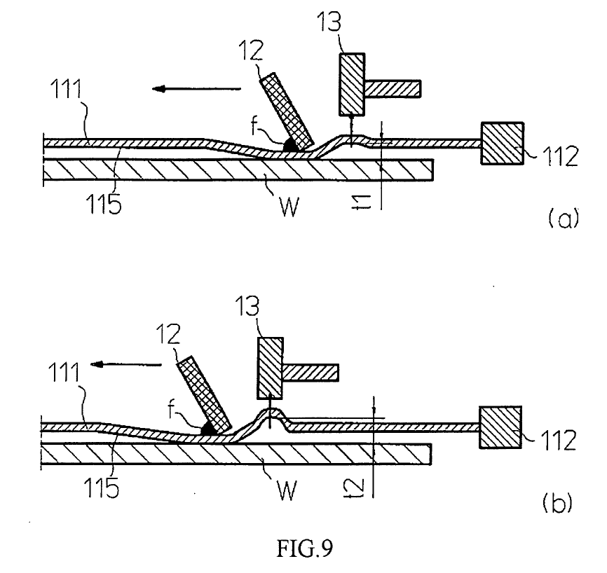

The reason for forming the elevator means 77 is as follows. On the mask 111 supported by the supporter 112, rigidity is not uniform. Therefore, when the mask 111 is pulled up by the same pulling force, as shown in FIGS. 9(a) and (b), a pull distance t2 is large in the central section which is far from the supporter 112 with low rigidity, and a pull distance t1 is small in the edge section which is close to the supporter 112 with high rigidity therefore, separability is not uniform over the mask 111.

Then, by using the elevator means 77, the height of the magnetic force generating means 13 can be adjusted by the elevator means 77, and the magnetic force acting on mask 111 by magnetic force generating means 13 can be controlled properly, therefore the pull distance of the mask 111 can be made uniform. When the reproducibility of the rigid variation over the mask 111 is excellent, the pull distance of the mask 111 can be made constant by the elevating elevator means 77 in a fixed pattern. If the position of the above-mentioned elevator means is suitably controlled based on the amount of the pull distance measured by the measurement means, the pull distance can be controlled more precisely, and separability can be made uniform. Although the magnetic force generating means 13 and the mask 111 do not contact with each other when the mask 111 is pulled in FIG. 9, this control can be carried out irrespective of whether this operation is carried out in contact or non-contact condition.

In the screen printing apparatus 8 in FIG. 8(b), an electromagnet (magnetic force generating means) 83 as a magnetic force generating means, and a magnetic force control means (pulling force control means) 89 which controls the magnetic force by the electromagnet 83 are formed. By this screen printing apparatus 8, it becomes possible to make the pull distance of the mask 111 almost uniform like the above, by controlling the magnetic force suitably generated by the electromagnet 83 using the magnetic force control means 89.

### The 4^{th} Embodiment

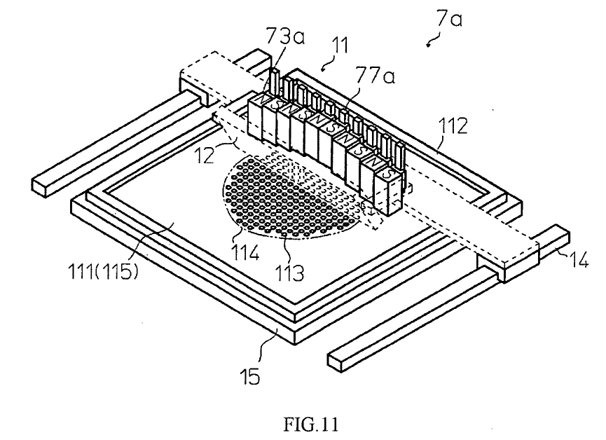

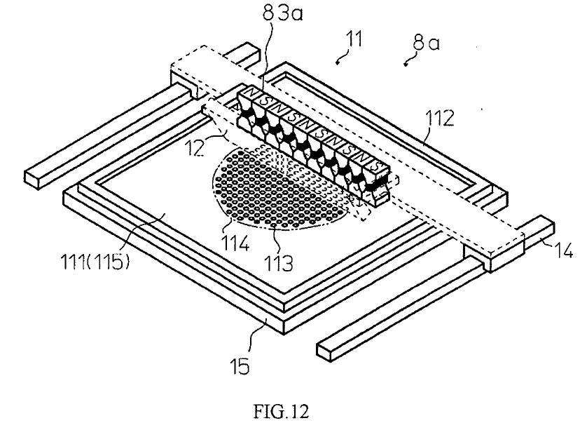

The 4th embodiment of this invention is explained with reference to FIGS. 11 and 12. FIGS. 11 and 12 show perspective views showing the outline composition of the screen printing apparatus 7a and 8a of the 4th embodiment. In FIGS. 11, 12, while attaching same numerals for same components as the screen printing apparatus 1 of the 1st embodiment, explanations are omitted for these components, and for easy understanding, a part of the horizontal displacement means 14 and the squeegee 12 are shown by the dashed line.

In FIG. 11, numeral 73a shows the magnetic force generating means of the screen printing apparatus 7a. The magnetic force generating means 73a is attached to a horizontal displacement means 14 so that it may be located behind this the squeegee 12 along the moving direction of the squeegee 12 driven by the horizontal displacement means 14, and it moves synchronously with the squeegee 12, keeping the distance to the squeegee 12 at a predetermined value. The magnetic force generating means 73a is formed to cover the whole print area 114 in size along the direction perpendicular to the moving direction of the squeegee 12. This magnetic force generating means 73a comprises two or more magnetic force generating parts 731a, and each magnetic force generating part 731a is attached to the horizontal displacement means 14 via the following elevator means (pulling force control means) 77a in line. The magnetic force generating part 73a is formed so that adjoining magnetic poles are opposite to each other, as the magnetic force generating means 13 of the 1st embodiment.

In FIG. 12, numerals 83a shows two or more electromagnets (magnetic force generating part) which are the magnetic force generating means of the screen printing apparatus 8a, and are formed like the above-mentioned permanent magnet 73a. The unillustrated magnetic force control means (pulling force control means) is connected to each electromagnet 83a, and magnetic force is controlled for every electromagnet 83a.

In the screen printing apparatus 7a and 8a of the 4th embodiment shown in FIGS. 11 and 12, also in the direction perpendicular to the moving direction of the squeegee 12, the pull distance of the mask 111 can be made uniform by the elevator means 77a or the magnetic force control means, like the screen printing apparatus 7 and 8 of the 3^{rd} embodiment, therefore, separability of the mask 111 can be made uniform. Although the magnetic force generating means 13 and the mask 111 do not contact with each other when the mask 111 is pulled in FIG. 9, this control can be carried out irrespective of whether this operation is carried out in contact or non-contact condition. Also in these screen printing apparatus 7a and 8a, the mask 111 can be pulls up, where the magnetic force generating means 73a or 83a, and the mask 111 are in contact or in non-contact condition.

What is claimed is:

1. A screen printing apparatus which prints a print material on a work in a predetermined pattern, comprising;
a printing means including, a printing member with elasticity and with soft magnetism, with opening corresponding to said pattern, with a print area to which said print material is supplied and in which said opening is included, with one face which is aligned with one face of said work in predetermined positional relation, and also including a supporter supporting said printing member,
a feeding means supplying said print material while pushing said print area from another face of said printing member, formed so that upper part of said printing member can move along one direction at least,
a magnetic force generating means pulling up said printing member synchronously with said feeding means, formed behind said feeding means to cover said print area along moving direction of said feeding means,
wherein, said magnetic force generating means comprises two or more magnetic domains on one face facing said printing member, and magnetic poles of adjoining said magnetic domains are opposite to each other.

2. The screen printing apparatus according to claim 1,
wherein said adjoining magnetic domains are formed to be in contact with each other.

3. The screen printing apparatus according to claim 2,
wherein a piece with soft magnetism is formed on another face of said magnetic force generating means, covering said another face.

4. The screen printing apparatus according to claim 1,
wherein said adjoining magnetic domains are formed not to be in contact with each other, and magnetic domains on a face facing said one face of said magnetic force generating means are combined magnetically.

5. The screen printing apparatus according to claim 1,
wherein said magnetic domains are located in line being at certain angles with moving direction of said feeding means.

6. The screen printing apparatus according to claim 1,
wherein said magnetic domains consist of permanent magnets.

7. The screen printing apparatus according to claim 1,
wherein the magnetic force by two or more of said magnetic domains is controlled so that pull distance of said printing member by said magnetic force generating means is set almost uniform along direction perpendicular to moving direction of said feeding means.

8. The screen printing apparatus according to claim 1,
wherein said feeding means is a squeegee located so that one end of said squeegee is set to be in contact with another face of said printing member.

9. The screen printing apparatus according to claim 1,
wherein said work is electronic device, and at least flux is included in said print material.

10. The screen printing apparatus according to claim 1,
wherein one face of said printing member is aligned with one face of said work so that distance between them is set to a predetermined value.

11. A screen printing apparatus which prints a print material on a work in a predetermined pattern, comprising;
a printing means including a printing member with elasticity and with soft magnetism, with opening corresponding to said pattern, with a print area to which said print material is supplied and in which said opening is included, with one face which is aligned with one face of said work in predetermined positional relation, and a supporter supporting said printing member,
a feeding means supplying said print material while pushing said print area from another face of said printing member, formed so that upper part of said printing member can move along one direction at least,
a magnetic force generating means pulling up said printing member synchronously with said feeding means not in contact with said printing member, formed behind said feeding means to cover said print area along moving direction of said feeding means,
wherein, said magnetic force generating means comprises two or more magnetic domains on one face facing said printing member, and magnetic poles of adjoining said magnetic domains are opposite to each other.

12. The screen printing apparatus according to claim 11,
wherein said adjoining magnetic domains are formed to be in contact with each other.

13. The screen printing apparatus according to claim 12,
wherein a piece with soft magnetism is formed on another face of said magnetic force generating means, covering said another face.

14. The screen printing apparatus according to claim 11,
wherein said adjoining magnetic domains are formed not to be in contact with each other,
and magnetic domains on a face facing said one face of said magnetic force generating means are combined magnetically.

15. The screen printing apparatus according to claim 11,
wherein said magnetic domains are located in line being at certain angles with moving direction of said feeding means.

16. The screen printing apparatus according to claim 11,
wherein said magnetic domains consist of permanent magnets.

17. The screen printing apparatus according to claim 11,
wherein the magnetic force by two or more of said magnetic domains is controlled so that pull distance of said printing member by said magnetic force generating means is set almost uniform along direction perpendicular to moving direction of said feeding means.

18. The screen printing apparatus according to claim 11,
wherein said feeding means is a squeegee located so that one end of said squeegee is set to be in contact with another face of said printing member.

19. The screen printing apparatus according to claim 11,
wherein said work is electronic device, and at least flux is included in said print material.

20. The screen printing apparatus according to claim 11,
wherein one face of said printing member is aligned with one face of said work so that distance between them is set to a predetermined value.

21. A screen printing method to print a print material on a work in a predetermined pattern, comprising the steps of;
aligning one face of an elastic printing member including opening corresponding to said pattern, with one face of said work, in predetermined positional relation,
pushing print area to which said print material is supplied onto said printing member by another face of said printing member, and supplying said print material on said print area while moving a feeding means from one end to another end of said printing member,
pulling up said printing member synchronously with said feeding means just after said print material is supplied on said print area, so that pull distance is set almost uniform along the direction perpendicular to said moving direction of said feeding means.

22. The screen printing method according to claim 21,
wherein said printing member is pulled up by magnetic force generated by two or more magnetic domains.

23. The screen printing method according to claim 21,
wherein said pull distance of said printing member is controlled to be almost uniform, when said feeding means moves from one end to another end.

24. The screen printing method according to claim 22,
wherein said pull distance of said printing member is controlled to be almost uniform, when said feeding means moves from one end to another end.
